(19) United States
(12) Patent Application Publication
(10) Pub. No.: US 2018/0219694 A1
(43) Pub. Date: Aug. 2, 2018

(54) METHOD FOR SEARCHING IDENTIFIER IN MULTI-DROP COMMUNICATION

(71) Applicant: ROBOTIS CO., LTD., Seoul (KR)

(72) Inventors: Byoung Soo KIM, Seoul (KR); Dae-Sung CHOI, Bucheon-si (KR)

(73) Assignee: ROBOTIS CO., LTD., Seoul (KR)

(21) Appl. No.: 15/421,448

(22) Filed: Feb. 1, 2017

(51) Int. Cl. H04L 12/18; H04L 12/40

(52) U.S. Cl. CPC H04L 12/1881; H04L 12/1868; H04L 12/40163

(57) ABSTRACT

A method for searching an identifier in multi-drop communication comprises: a transmission step in which a master controller generates a command packet and transmits the command packet to a communication bus; and a response step in which a plurality of slave controllers generate state packets corresponding to a response to the command packet, respectively, and sequentially transmit the state packets through the communication bus, wherein in the response step, the plurality of slave controllers check the command packet in accordance with determined priority, and respond by the state packets in accordance with the priority.

### BACKGROUND

The present invention relates to a method for searching an identifier in multi-drop communication, and more specifically, to a method for searching an identifier in multi-drop communication to reduce identifier searching procedure and time through improvement for a problem of a ping command transmitted to unspecified individuals and a conventional problem of having to specify an identifier.

In multi-drop communication, slave controllers respond to a command of a master controller on the basis of an identifier (hereinafter, referred to as ID).

Accordingly, a slave controller cannot arbitrarily occupy a communication bus, and occupies a communication bus for a limited time for response only when a master controller requests. For example, when a master controller needs position information of a slave controller [1] with an ID of ‘1’, the master controller transmits a command packet for requesting the slave controller [1] to transmit position information. In this case, all slave controllers should stand by in reception state. When the command packet is received by the master controller, the command packet is analyzed. When the ID coincides, the slave controller [1] occupies the communication bus and transmits a state packet including position information.

As described above, a method that a master controller provides occupancy right (transmission right) of a communication bus to a slave controller is based on the ID of the slave controller. For this reason, the master controller has to exactly know IDs of slave controllers connected to the communication bus. Accordingly, a procedure of searching an ID of a slave controller is very important.

In the prior art, in order to search an ID of a slave controller, a command packet is transmitted to each ID, and confirms a response (state packet) thereof.

If the number of IDs of slave controllers connectable to a communication bus is 1,000 (0 to 999), the master controller transmits a command packet 1,000 times from slave controller [0] to slave controller [999] to confirm the IDs of the slave controllers connected to the communication bus. In this case, when a response (state packet) is received from an arbitrary slave controller, the master controller can confirm that the slave controller having the ID is connected to the communication bus.

If a baud rate is 57,600 bps and lengths of a command packet and a state packet are 6 bytes, a packet transmission time is about 1 ms. The time taken for a slave controller to analyze a command packet and to generate a state packet varies somewhat in accordance with a processer (CPU), but the process can be completed within a very short time, and it is assumed that the time is 0.3 ms.

In the procedure of searching an identifier in the prior art, the time taken to confirm whether one slave controller is connected to a communication bus is 2.6 ms irrespective of existence or non-existence of the slave controller on the communication bus. When 1,000 IDs have to be searched, a total of 2.6 s is taken.

Meanwhile, the master controller is involved in the communication bus at every moment, and has to determine which slave controller occupies the communication bus. In other words, the master controller transmits a command packet to slave controller [0] (Slave [0]) to give occupancy right of the communication bus to slave controller [0] (Slave [0]). Slave controller [0] (Slave [0]) temporarily receives the occupancy right of the communication bus, transmits a state packet, and then returns the bus occupancy right to the master controller. The master controller transmits a command packet to slave controller [1] (Slave [1]) to give occupancy right of the communication bus to slave controller [1] (Slave [1]), and re-acquires the occupancy right of the bus using timeout when there is no slave controller [1] (Slave [1]).

If a plurality of baud rates is used between a master controller and slave controllers, the identifier searching procedure described above has to be performed for each baud rate.

For example, it is assumed that 10 kinds of baud rates of slave controllers are selectable, and 1,000 (0 to 999) IDs of slave controllers can be set for each baud rate. Generally, even if ignoring the time taken for a master controller to change the baud rate and parameters by which a packet transmission time is changed when the baud rate is changed, the total time necessary to search IDs of slave controllers connected to the communication bus is 2.6 ms*1,000*10=26 seconds as a product of 2.6 ms of the time to figure out whether one slave controller is connected to the communication bus, 1,000 of the number of IDs of slave controllers, and 10 of selectable baud rates.

Finally, in the prior art, command packets specifying IDs of a plurality of slave controllers, that is, a command set is required, a procedure of searching IDs of slave controllers is complicated, and a long time to search the IDs of the slave controllers is taken.

Meanwhile, when a ping command in the prior art is used, it is possible to apply a broadcasting ID. For example, when there is only one slave controller on a communication bus and a master controller requests by broadcasting ID, the slave controller occupies the communication bus and can transmit the corresponding response. However, when there are two or more slave controllers and the master controller requests by broadcasting ID, each slave controllers simultaneously occupy the communication bus and transmit the corresponding responses. Accordingly, signals transmitted through the communication bus may be distorted, and an error may occur. In order to solve such problems, the conventional system is designed so as not to respond when a state packet is requested for the slave controllers by a broadcasting ID. In other words, in the prior art, when a ping command is used, slave controllers which receive a command set as a broadcasting ID do not simultaneously respond or not respond at all. Accordingly, there is a problem that the master controller cannot confirm the ID of the slave controller connected to the communication bus.

### SUMMARY

The invention has been made in consideration of the above description, and particularly, the invention is to provide a method for searching an identifier in multi-drop communication to solve a problem that a master controller cannot confirm an ID of a slave controller connected to a communication bus by a ping command transmitted to unspecified individuals, and a conventional problem of a complicated identifier searching procedure and a long searching time occurring because a state packet has to be requested by specifying an identifier.

According to an aspect of the invention, there is provided a method for searching an identifier in multi-drop communication, including: a transmission step in which a master controller generates a command packet and transmits the command packet to a communication bus; and a response step in which a plurality of slave controllers generate state packets corresponding to a response to the command packet, respectively, and sequentially transmit the state packets through the communication bus, wherein in the response step, the plurality of slave controllers check the command packet in accordance with determined priority, and respond by the state packets in accordance with the priority.

Preferably, in the response step, the n-th slave controller with the n-th priority of the plurality of slave controllers responds by the n-th state packet corresponding to the command packet, and then the (n+1)-th slave controller with the (n+1)-th priority responds by the (n+1)-th state packet corresponding to the command packet.

Preferably, in the response step, a response waiting time permitted to respond in correspondence with the command packet is set for each of the plurality of slave controllers.

More preferably, in the response step, when the n-th slave controller with the n-th priority of the plurality of slave controllers does not respond by a state packet corresponding to the command packet until an expiration time point of the response waiting time, the (n+1)-th slave controller with the (n+1)-th priority occupies the communication bus to respond by a state packet corresponding to the command packet. Alternatively, when the n-th slave controller with the n-th priority of the plurality of slave controllers responds by a state packet corresponding to the command packet before the expiration time point of the response waiting time, the response waiting time set for the n-th slave controller expires at the response time point of the n-th slave controller, and the (n+1)-th slave controller with the (n+1)-th priority occupies the communication bus to respond by a state packet corresponding to the command packet.

Preferably, the command packet is configured excluding identification information for identifying each of the plurality of slave controllers.

Preferably, the command packet has an identifier field including a broadcasting identifier which does not specify each of the plurality of slave controllers.

According to another aspect of the invention, there is provided a method for searching an identifier in multi-drop communication including: transmitting the n-th state packet through a communication bus occupied by the n-th slave controller in response to a command packet received by the n-th slave controller of a plurality of slave controllers; releasing occupancy right of the communication bus by the n-th slave controller; and transmitting the (n+1)-th state packet through the communication bus occupied by the (n+1)-th slave controller in response to a command packet received by the (n+1)-th slave controller with the next priority of the priority of the n-th slave controller.

Preferably, the command packet is configured excluding an identifier field for specifying each of the plurality of slave controllers.

Preferably, the command packet is configured including a broadcasting identifier which does not specify the plurality of slave controllers.

According to the present invention, a slave controller occupies a communication bus in accordance with determined priority and transmits a state packet, and a command set specifying an ID of a slave controller is not required to search IDs of a plurality of slave controllers connected to the communication bus by a master controller, thus a procedure in which the master controller assigns occupancy right of the communication bus at every moment is not required. Accordingly, an intervention portion of a master controller is deleted in searching IDs of a plurality of slave controllers, and it is possible to significantly shorten a searching time of the entire IDs. In other words, a master controller does not directly manage occupancy right of a communication bus, and each of the slave controllers determines occupancy or non-occupancy of a communication bus in accordance with determined priority by itself. Accordingly, the ID searching procedure is simplified, and a searching time of the entire IDs is shortened.

In addition, the present invention may exclude an ID field from fields constituting a command packet, and can be easily applied even to a technique of applying a broadcasting ID.

### DESCRIPTION OF THE DRAWINGS

FIG. 1 is a diagram illustrating an identifier searching procedure in multi-drop communication according to the invention; and

FIG. 2 is a diagram illustrating format configurations of a command packet and a state packet when a broadcasting ID is applied in an embodiment of the invention.

### DETAILED DESCRIPTION

The other objects, features, and advantages of the invention will be clarified through detailed description of embodiments with reference to the accompanying drawings.

Hereinafter, a configuration and an operation of embodiments of the invention will be described with reference to the accompanying drawings, the configuration and the operation of the invention illustrated in the drawings and described thereby are described as at least one embodiment, and the technical spirit, main configuration and operation of the invention are not limited thereby.

Hereinafter, a preferred embodiment of a method for searching an identifier in multi-drop communication according to the invention will be described in detail with reference to the accompanying drawings.

In the invention, a procedure in which a master controller assigns occupancy right of a communication bus at every moment is not required, and the master controller transmits a command packet which does not specify an ID of a slave controller. In response to such a command packet, the slave controller occupies the communication bus in accordance with determined priority and transmits a state packet.

In the invention, that a command packet transmitted by a master controller does not specify an ID of a slave controller means that an ID field to which an ID of a slave controller is inserted is deleted from fields of a command packet, or a broadcasting ID is inserted to an ID field although a command packet has the ID field.

In addition, in the invention, a master controller requests specific states of slave controllers through a command packet while not specifying an ID of each slave controller and, in response thereto, the slave controller transmits a state packet including state information in accordance with the request of the command packet. In this case, the state information may include the location of the slave controller, occurrence or non-occurrence of an error, version information, and the like.

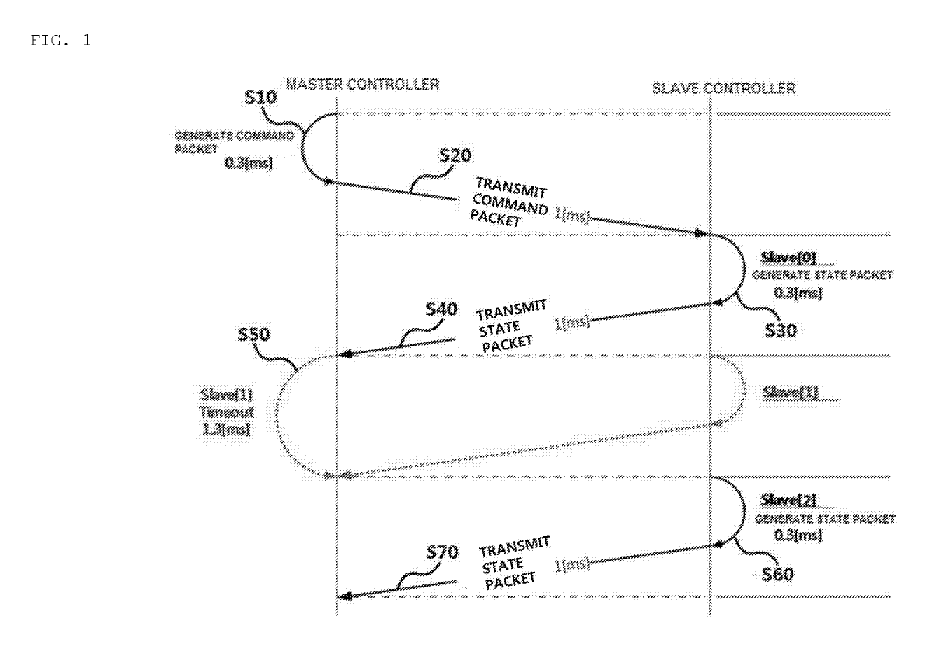

FIG. 1 is a diagram illustrating an identifier searching procedure in multi-drop communication according to the invention.

Referring to FIG. 1, a master controller generates a command packet when specific information is necessary (S10).

As an example, a command packet generated by the master controller may be configured excluding identification information for identifying each of a plurality of slave controllers corresponding to targets to request specific information. In other words, the master controller configures a command packet excluding an ID field for specifying each of the plurality of slave controllers, thereby generating a command packet excluding the ID field.

As another example, a command packet generated by the master controller may have an ID field including a broadcasting ID which does not specify each of a plurality of slave controllers corresponding to targets to request specific information.

Subsequently, the master controller transmits the generated command packet to a communication bus (S20).

After the response of a slave controller with the previous priority, each of the other slave controllers generates a state packet corresponding to the response of the received command packet, and responds by sequentially transmitting the state packet in accordance with priority through the communication bus (S30, S40, S60, and S70). As for the response by a plurality of slave controllers, the plurality of slave controllers check the command packet in accordance with determined priority, and respond by state packets in accordance with the priority.

For example, the zeroth slave controller (Slave [0]) with the zeroth priority of the plurality of slave controllers generates the zeroth state packet corresponding to a command packet (S30), and transmits the generated zeroth state packet by occupying the communication bus (S40).

After the zeroth slave controller (Slave [0]) transmits the zero-th state packet, the zeroth slave controller (Slave [0]) releases the occupancy right of the communication bus.

Meanwhile, in the invention, a response waiting time permitted to respond in correspondence with a command packet may be set for each of a plurality of slave controllers. In this case, the response waiting time can be understood as a time maximally permitted in transmitting a state packet for a slave controller, which is not connected to the communication bus, of a plurality of slave controllers, and it may be determined that a slave controller which does not transmit a state packet until a time point when the waiting time expires is not connected to the communication bus. Of course, when a specific slave controller responds by a state packet within the response waiting time, a process of ending before the response waiting time assigned to the slave controller expires is performed, and the state becomes a state where a slave controller with the next priority can transmit a state packet.

More specifically, when the first slave controller (Slave [1]) with the first priority of the plurality of slave controllers does not respond by a state packet corresponding to a command packet until the expiration time point (timeout) of the response waiting time, it is determined that the first slave controller (Slave [1]) is not connected to the communication bus (S50).

As an example, when assuming that a packet transmission time is 1 ms and a generation time of a state packet is 0.3 ms, the response waiting time described above may be set to 1.3 ms until the time point when a master controller completely receives a state packet.

However, in the invention, when the entire state packet generated by a slave controller is completely loaded on the communication bus after the generation time of the state packet, a slave controller with the next priority can start generating a state packet. Accordingly, the response waiting time may not be set to the time point when the master controller completely receives the state packet, but may be set to a time less than such time. As an example, a state packet generation time may be 0.3 ms, time until a state packet is completely loaded on the communication bus may be (1-a) ms, less than 1 ms which is the packet transmission time, and thus the response waiting time may be set to (1.3-a) ms. Accordingly, the time when it is possible to determine whether a plurality of slave controllers are connected to the communication bus through counting of a response waiting time may be (1.3-a) ms, less than 1.3 ms. Accordingly, when a slave controller transmits a state packet in accordance with priority without intervention of the master controller as in the invention, it is possible to set an expiration time (timeout) of a timer for determining that a slave controller is not connected to the communication bus, to be shorter.

Meanwhile, when the first slave controller (Slave [1]) with the first priority of a plurality of slave controllers responds by a state packet corresponding to a command packet before expiration of the response waiting time, the response waiting time set for the first slave controller is expired at the response time point of the first slave controller (Slave [1]), and the second slave controller with the second priority can respond by a first state packet corresponding to a command packet by occupying the communication bus.

FIG. 1 illustrates an example in which, when the first slave controller (Slave [1]) with the first priority does not respond by a state packet corresponding to a command packet until an expiration time point (timeout), a response waiting time set for the first slave controller (Slave [1]) expires, and then the second slave controller (Slave [2]) with the second priority responds by a state packet corresponding to a command packet.

Accordingly, the second slave controller (Slave [2]) with the second priority generates a second state packet corresponding to a command packet (S60), and transmits the second state packet through the occupied communication bus (S70).

In the invention, priority is assigned to a plurality of slave controllers, and it is possible to respond by sequentially transmitting state packets in ascending order or descending order based on the priority.

Applying the procedure of FIG. 1 described above, a procedure in which a main controller controls a plurality of network-type actuator modules through a communication bus will be described as an example.

First, a main controller generates a command packet, and transmits the command packet through a communication bus.

Subsequently, a plurality of network-type actuator modules check the received command packet in accordance with determined priority, and each network-type actuator module generates a state packet corresponding to the received command packet, and sequentially responds through a communication bus.

Particularly, the n-th actuator module with the n-th priority of the plurality of network-type actuator modules responds by the n-th state packet corresponding to the received command packet, and then the (n+1)-th actuator module with the (n+1)-th priority can respond by the (n+1)-th state packet corresponding to the received command packet.

If the (n+1)-th actuator module with the (n+1)-th priority does not respond until the time point when the response waiting time described above expires, the (n+2)-th actuator module with the (n+2)-th priority can respond by the (n+2)-th state packet corresponding to a command packet after the response waiting time expires.

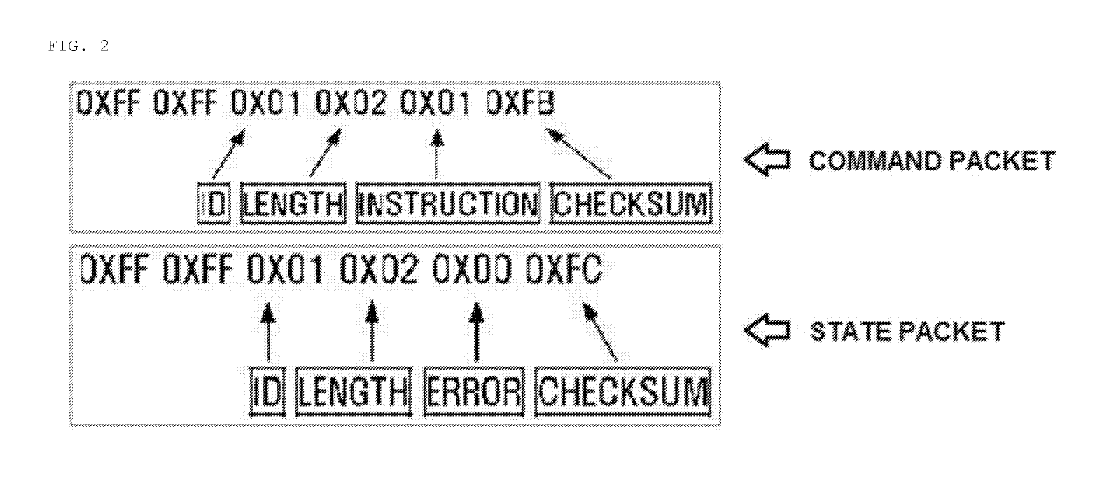

FIG. 2 is a diagram illustrating format configuration of a command packet and a state packet when a broadcasting ID is applied in an embodiment of the invention, and the command packet according to the embodiment of the present invention may be configured including a broadcasting ID which does not specify a plurality of slave controllers.

Referring to FIG. 2, a master controller generates a command packet using a broadcasting ID which specifies unspecified individuals for a ping command, and transmits the generated command packet through a communication bus.

In the invention described above, a master controller does not intervene in assigning occupancy right of a communication bus, and a slave controller determines whether to occupy the communication bus in accordance with priority.

Accordingly, since priority to transmit a state packet is determined for all slave controllers connected to the communication bus, each slave controller may have a time to prepare a state packet thereof, that is, a generation time of a state packet. In other words, while the n-th slave controller transmits a state packet, the (n+1)-th slave controller can generate a state packet thereof. Accordingly, slave controllers with lower priority excluding the slave controller with the highest priority can reduce a time for generating a state packet.

Hitherto, the preferred embodiment of the invention has been described, but a person skilled in the art can embody the invention by modification within the scope which does not deviate from the essential characteristics of the invention.

Therefore, the embodiment described therein should be considered in terms of a descriptive viewpoint not a definite viewpoint, the scope of the invention is disclosed in Claims not in the description, and it should be interpreted that all differences in the scope equivalent thereto are included in the invention.

While the present invention has been described with respect to the specific embodiments, it will be apparent to those skilled in the art that various changes and modifications may be made without departing from the spirit and scope of the invention as defined in the following claims.

What is claimed is:

1. A method for searching an identifier in multi-drop communication comprising:
a transmission step in which a master controller generates a command packet and transmits the command packet to a communication bus; and
a response step in which a plurality of slave controllers generate state packets corresponding to a response to the command packet, respectively, and sequentially transmit the state packets through the communication bus,
wherein in the response step, the plurality of slave controllers check the command packet in accordance with determined priority, and respond by the state packets in accordance with the priority.

2. The method for searching an identifier in multi-drop communication according to claim 1, wherein in the response step, the n-th slave controller with the n-th priority of the plurality of slave controllers responds by the n-th state packet corresponding to the command packet, and then the (n+1)-th slave controller with the (n+1)-th priority responds by the (n+1)-th state packet corresponding to the command packet.

3. The method for searching an identifier in multi-drop communication according to claim 1, wherein in the response step, a response waiting time permitted to respond in correspondence with the command packet is set for each of the plurality of slave controllers.

4. The method for searching an identifier in multi-drop communication according to claim 3, wherein in the response step, when the n-th slave controller with the n-th priority of the plurality of slave controllers does not respond by a state packet corresponding to the command packet until an expiration time point of the response waiting time, the (n+1)-th slave controller with the (n+1)-th priority occupies the communication bus to respond by a state packet corresponding to the command packet, or when the n-th slave controller with the n-th priority of the plurality of slave controllers responds by a state packet corresponding to the command packet before the expiration time point of the response waiting time, the response waiting time set to the n-th slave controller is expired at the response time point of the n-th slave controller, and the (n+1)-th slave controller with the (n+1)-th priority occupies the communication bus to respond by a state packet corresponding to the command packet.

5. The method for searching an identifier in multi-drop communication according to claim 1, wherein the command packet is configured excluding identification information for identifying each of the plurality of slave controllers.

6. The method for searching an identifier in multi-drop communication according to claim 1, wherein the command packet has an identifier field including a broadcasting identifier which does not specify each of the plurality of slave controllers.

7. A method for searching an identifier in multi-drop communication comprising:
transmitting the n-th state packet through a communication bus occupied by the n-th slave controller in response to a command packet received by the n-th slave controller of a plurality of slave controllers;
releasing occupancy right of the communication bus by the n-th slave controller; and
transmitting the (n+1)-th state packet through the communication bus occupied by the (n+1)-th slave controller in response to a command packet received by the (n+1)-th slave controller with the next priority of the priority of the n-th slave controller.

8. The method for searching an identifier in multi-drop communication according to claim 7, wherein the command packet is configured excluding an identifier field for specifying each of the plurality of slave controllers.

9. The method for searching an identifier in multi-drop communication according to claim 7, wherein the command packet is configured including a broadcasting identifier which does not specify the plurality of slave controllers.
